(19) United States
(12) Patent Application Publication
(10) Pub. No.: US 2008/0208971 A1
(43) Pub. Date: Aug. 28, 2008

(54) Social Networking via Communications over Interactive Devices

(76) Inventors: Darryl J. Costin, Westlake, OH (US); Darryl J. Costin, Westlake, OH (US); Scott C. Harris, Rancho Santa Fe, CA (US)

Correspondence Address: Law Office of Scott C Harris Inc, PO Box 1389, Rancho Santa Fe, CA, 92067, US

(21) Appl. No.: 12/034,172

(22) Filed: Feb. 20, 2008

Related U.S. Application Data
(60) Provisional application No. 60/890,770, filed on Feb. 20, 2007.

(51) Int. Cl. G06F 15/16; G06F 7/06

(52) U.S. Cl. 709/204; 707/3; 707/E17.108

(57) ABSTRACT

A social networking part for a mobile phone that allows initiating communications with persons within a vicinity.

This application claims priority from Provisional application No. 60/890,770, filed Feb. 20, 2007, the disclosure of which is herewith incorporated by reference.

### BACKGROUND

Social networking has become a lucrative business. Myspace.com, for example, was so popular that it has been purchased by News Corp. for $500 million. Several other websites are following in the footsteps of Myspace.com. Companies like IBM and Microsoft are also interested in social networking as web applications.

Applications of social networking include finding a new job, making new friends, dating, chatting, and other applications. It allows people to reach out beyond their current contacts of friends, family, and co-workers. It also allows finding and contacting people you already know via an alternative method to the usual telephone and/or email. People increase their social contacts via “networking”, e.g., meeting new people through their current contacts or through online websites.

New applications and new ways of meeting people are useful in social networking applications.

### SUMMARY

The present application discloses networking over interactive electronic devices.

An embodiment discloses using such devices to wirelessly send information to people in a specified area.

### BRIEF DESCRIPTION OF THE DRAWINGS

In the Drawings:

FIG. 1 shows an operation between cell phone users; and

FIG. 2 illustrates a flowchart of operation.

### DETAILED DESCRIPTION

An embodiment describes a new social networking system and technique. A portable communicator, e.g., cell phone, ipod, pda, mp3 player, gps device, portable computer, or any other such device is used to send and receive information, preferably wirelessly.

A user provides information about themselves to other people who are in close proximity to the communicator. The user can also receive information from others, both the people that they specifically send to, and also to/from other people, including anonymous senders.

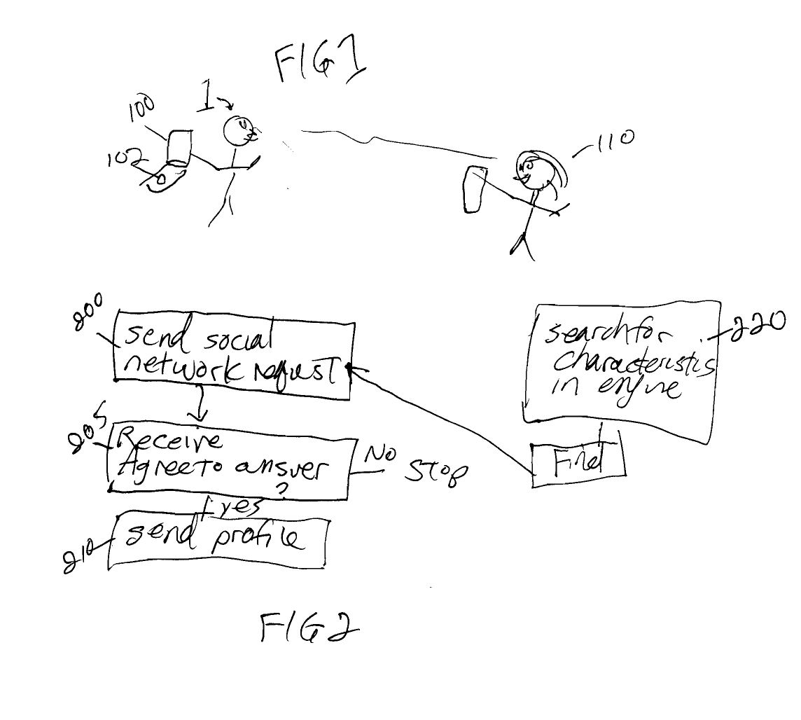

An embodiment is shown in FIG. 1. A user 1 has a communicator, here a cell phone 100. The user 1 sees another user, here user 2. User 1 is interested in meeting user 2. User 1 therefore makes an actuation on cell phone 100, by pressing a special “meet me” button 102. Actuating this button indicates that the user wants to obtain information about a person of interest. In an embodiment like FIG. 1, the other person 110 is within the line of sight of user 1.

The request can be beamed via infra red or Bluetooth or via the cellular carrier, or by some other method from user 1's cell phone 100 to recipient's 110 cell phone 115. FIG. 2 shows sending the social networking request as step 200. Preferably, the format for the “beaming” is a format that operates over short ranges, e.g., line of sight, preferably 100 feet or less. As the technology develops so will the range increase. The request can include personal information about user 1, for example, a picture, a resume, an item for sale, a service needed, or other information, to give the recipient enough information to determine if they want to answer at 205. If recipient 110 answers, user 1 receives the information back from their cell phone 115 to recipient's cell phone 100 at 210, e.g., with a profile. Once both parties have exchanged initial information, they have the option to have access to each other's network of contacts and other information.

All recipients in the beamed area—e.g., the line of sight or Bluetooth range, of cell phone 100, may receive the request. Therefore, the request can include identifying information about the person it is directed to. For example, the request may say—this is for the man in the blue suit at the corner of 3^{rd} an Main. This is for the red-haired woman with the red shoes.

If the user 1 can see the cell phone of the user 110, the request can be personalized to that cell phone, for example. The request may be directed only to Motorola cell phones within the beamed area, for example.

The information received via the cell phone 110 could include data, pictures, short video segments, or any other kind of information that can be received by a cell phone and sent.

If the recipient responds, the user and recipient can exchange email addresses, cell phone numbers, user id information, or other ways to get in touch with each other in other contexts. This, in essence, establishes a two way social networking system through the use of cell phones, proximity contact and proximity wireless communication, e.g., infra-red beaming, wireless networking, radio frequency communication or scanning technology.

Another embodiment may broadcast the user's personal information to everyone in range.

According to an embodiment, the information being sent is just like the kind of information you would be willing to share on Myspace.com. A recipient user can set their cell phone to automatically provide selected information about other users who requests such information. They can also review the requests, and decide whether to accept the requesting user as a “friend” after reviewing the kind of information that has been sent.

The information sent can be a complete pre-stored profile, stored, for example, in the phone or on a server. Alternately one could choose to send selected information manually once receiving the request for information. The manual send could allow the user to enter specific information, or select a subset of information from the stored information. The user can also politely refuse and not send the information at all.

This new exciting technology produces numerous applications, and introduces a whole new means for social networking. One could program their communicator, e.g., their cell phone, only to provide their resume to interested parties who send a request for your resume. The resume, however, might only be sent to people in a certain geographical area, e.g., close to the other user. Obtaining the right job the first time could be much easier with this network concept. Both employers searching for new employees and employees searching for new jobs could benefit.

This can be used as a means for meeting people at a club. It can be used to request social information about persons, e.g., whether they are dating, or what kind of person would they prefer to date. In a club, a user could transmit a request, for example, for any person who likes baseball, or any woman who likes baseball, or any woman taller than 6 foot, or any number of different criteria. The criteria can be physical criteria such as height, weight, hair, etc. The criteria can be interests, likes, dislikes. The criteria can be based on items the user owns, a kind of car, kind of pet, breed of dog, or others. Any criteria can be used as part of the request. The request is beamed from your cell phone to their cell phone.

Some night clubs have introduced a form of social networking by installing traditional telephones on each table where people could talk to other people at different tables. The embodiment allows a user to use their own communicator, with all its personalization specific to the user, to initiate conversations and networking. It allows multiple different kinds of data to be beamed to the other cell phone, including social and religious preferences, job objectives, requirements for friendships, etc.

In addition to use in nightclubs etc, this system allows use in other less conventional meeting locations: on buses, cars, trains and airplanes; airports, waiting areas, grocery stores, etc to enhance social networking.

An embodiment allows individuals to automatically view profiles of others who get physically near to them. This may be set as a preference on the cell phone (e.g., yes/no), and also to set a preference for what information is allowed to be beamed to the anonymous viewers. For example, this may allow beaming a user name on a social networking site, without sending an actual name. It may allow sending picture, likes and dislikes, age, etc. Certain social networking systems, e.g., Myspace.com, allows a person to look up other people's profiles. In a similar way, this system allows simply using your cell phone to scan other people's information that walk or drive by, throughout your day (as long as that person has their preference set to allow this).

Another embodiment broadcasts likeness information from your phone to all phones in range; and correspondingly receives the likeness information from all phones in range. On any phone, then, you can see likenesses of all the people around you, and select a person to communicate with, by viewing all the likenesses.

Never again will you regret not approaching that certain someone, hoping to meet them. You can download their information and contact them at a later date via text, email, or other. The data thus transferred could go directly to your Myspace, Facebook, or any web page which stores information about friends and/or people that you would like to make friends with, or any other information. Shy people who shun talking with others if they aren't already friends, can grow their network in a more circumspect way. This tool can be used to find a new job, market your business, sell your house, make new friends, meet that special someone, buy and sell items, offer services, send distress signals, etc.

Another embodiment applies the techniques of the embodiment to scanning devices and cameras that scan bar codes or matrix codes to obtain information about a person.

Yet another means for such two way communication is via common wireless networks (WIFI). Public WiFi, for example is becoming much more available at airports and coffee houses. The social networking between devices that is disclosed herein can be used in these places, and can be used to determine information about, and establish communication with, people who are close and are in these kinds of places.

The embodiment discloses using any two devices which send signals to each other in line of sight proximity could send and receive information on a requested basis. Devices which send signals for data streaming, video streaming and video conferencing may be applicable.

The embodiment can also be used to constantly transmit information about yourself to others. For example, the device can be programmed to beam information to others that indicate you are searching for a sales position in the medical industry.

Another embodiment constantly sends requests for a person who has certain characteristics you are looking for.

An embodiment uses or accesses a search engine at 220, not unlike Google on the web, where you would send requests for any person who meets the criteria for which you are searching. This search engine can store information about all users in the local area for example. When a person comes into the local area, certain information about them is automatically taken from their profile and stored as part of the search engine. For example, this information can include physical characteristics, or other identifying information. The search engine may store this information, even when the user does not want to be contacted. When the user attempts to contact a specific person in their area, they may use the search engine to look up that person—e.g., who is the redhead within my line of sight? The search engine returns information about the person, including a unique address to contact the person's communicator, for example. The search engine may also store information saying “this person does not want to be contacted”, to avoid harassment of someone who does not wish to be part of the social network scene. Once the person is found, with either the search engine or other techniques at 225, the techniques disclosed above of sending information can be used.

The flowchart of FIG. 2, and all other flowcharts of operation, can be carried out in one or both users' cell phones, or in a cellular carrier's server.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes using cell phones, it can be used with any kind of communicator. The term “beaming” is used herein to refer to short range, e.g., line of sight, communication. It can also communicate using other formats.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A method comprising:
storing personal information on a portable communicator, in the form of a profile about a user; and
receiving a request for a social networking communication from another portable communicator; and
responsive to said request, sending information from said profile to a device that created said request.

2. A method as in claim 1, wherein said receiving comprises receiving in a format that can only be sent over a distance less than 100 ft.

3. A method as in claim 1, wherein said sending information includes sending a username on a social networking website.

4. A method as in claim 1, wherein said request is sent to all users within a specified area, and includes information identifying a specific person to which the request is directed.

5. A method as in claim 1, further comprising allowing a recipient of a request to deny the request.

6. A method as in claim 1, further comprising a search engine that allows searching characteristics of all persons within an immediate vicinity, and which allows sending said request to at least plural of said persons.

7. A method as in claim 1, wherein said request includes a request to be answered only by persons having a specific characteristic.

8. A method as in claim 1, further comprising a search engine that allows searching specific information about any subject from persons having such information within an immediate vicinity, and which allows sending said request to at least plural of said persons.

9. A method as in claim 1, wherein said request includes a request to be answered only by persons having a specific information.

10. A method as in claim 1, wherein said request is received by all communicators within a vicinity.

11. A method comprising:
sending, from a first portable communicator, a request to another portable communicator for further information about a first user of said another portable communicator;
receiving said further information from said another portable communicator; and
using said information to view further information about said first user and to initiate a communication with said first user.

12. A method as in claim 11, wherein said request includes information about a first user of said first portable communicator.

13. A method as in claim 11, wherein said sending comprises sending in a format that can only be sent over a distance less than 100 ft.

14. A method as in claim 11, wherein said further information includes a username on a social networking website.

15. A method as in claim 11, further comprising sending information indicative of a user's likeness to all phones in range.

16. A method as in claim 11, further comprising a search engine that allows searching characteristics of all persons within an immediate vicinity, and which allows sending said request to at least plural of said persons.

17. A method as in claim 11, further comprising a search engine that allows searching specific information about any subject from persons having such information within an immediate vicinity, and which allows sending said request to at least plural of said persons.

18. A personal communicator, comprising:
a profile storage part, that stores personal information, in the form of a profile about a user that is operating the personal communicator;
a communication part, that controls transmitting a request for a social networking communication to another portable communicator and receiving a request from another portable communicator, and responsive to said request, sending information from said profile to said another portable communicator that created said request.

19. A communicator as in claim 18, further comprising a control on said communication part, that commands a request from said another portable communicator.

20. A communicator as in claim 18, wherein said request is received by all communicators within a vicinity.

21. A communicator as in claim 18, further comprising a search engine that allows searching characteristics of all persons within a vicinity, and which allows sending said request to at least plural of said persons.

22. A communicator as in claim 18, further comprising a search engine that allows searching specific information about any subject from persons having such information within a vicinity, and which allows sending said request to at least plural of said persons.

23. A communicator as in claim 18 further comprising a reader for matrix codes being used for the profile storage part.

24. A communicator as in claim 23 wherein said request includes matrix codes, where such codes can be scanned and interpreted by another communicator receiving such codes.

25. A personal communicator comprising a communication part that can send personal alarms for immediate help needed to persons in the vicinity.
